(19) United States
(12) Patent Application Publication
(10) Pub. No.: US 2008/0206029 A1
(43) Pub. Date: Aug. 28, 2008

(54) Trailer support apparatus and method

(76) Inventor: Clayton Joseph Roubideaux, Utica, SD (US)

Correspondence Address: SCHWEGMAN, LUNDBERG & WOESSNER, P.A., P.O. BOX 2938, MINNEAPOLIS, MN, 55402, US

(21) Appl. No.: 11/712,229

(22) Filed: Feb. 28, 2007

(51) Int. Cl. B60P 1/02

(52) U.S. Cl. 414/441

(57) ABSTRACT

An apparatus includes a trailer support, and a lift mechanism attached to the trailer support. The apparatus also includes a first drive unit attached to the trailer support, and a second drive unit attached to the trailer support. The first drive unit steers the trailer support. The second drive unit moves the jack.

### FIELD OF THE INVENTION

The present invention is related to a trailer support apparatus and methods for making and using a trailer support apparatus.

### BACKGROUND OF THE INVENTION

When a trailer is parked and detached from a tow vehicle, a support is required for the trailer tongue. Although other objects might be used, generally a special purpose jack (called a trailer jack or tongue jack) attached to the tongue of the trailer or to the trailer itself is used. Trailer jacks generally are mounted vertically, or are pivotable to a vertical position, and have a telescoping portion which can be cranked upward or downward. Such trailer jacks provide static support, leveling, and facilitate detaching the tongue from the trailer hitch on the tow vehicle. The trailer or tongue of the trailer is detached by allowing the tongue of the trailer to be raised relative to the hitch and thereby disengage from the hitch. Large trailers generally have significant tongue weight for safety and control. The tongue jack must be able to support the tongue weight, and allow operation without undue effort.

In some instances it might be necessary to move a trailer after it has been detached from the tow vehicle. For example, a trailer may be stored in a garage and some people have difficulty maneuvering a trailer while backing with the trailer attached to the tow vehicle. Some find it much easier to detach the trailer and push the trailer into a space. In other instances, a trailer may have to be moved out of a storage space to be attached to a tow vehicle. In still other instances, a trailer may not be on a surface which would allow the trailer to be leveled. Reattaching the two vehicle may be too much of a hassle for moving the trailer a relatively small distance. In other instances, the detached tow vehicle may be unavailable for some time. For example, one of the users may have left the area after detaching an RV trailer. Older people may have a harder time pushing a trailer or may find it impossible to do. In still other instances, larger trailers, such as semi trailers, may need to be moved.

In other instances, it may be difficult to attach a trailer to a tow vehicle. Generally, the tow vehicle is moved into a position close to the point where it can be hitched to a trailer hitch on the tow vehicle. Many times, the operator can not see relative position between the trailer hitch on the vehicle and the hitch associated with the trailer. So, the driver of the two vehicle backs or positions the tow vehicle as close as he or she dares and then repositions the trailer so that the hitch will attach to the tow hitch on the tow vehicle.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures, and:

FIG. 1 is perspective view a trailer support positioned on a trailer, according to an example embodiment.

FIG. 2 is side view of a trailer support, according to an example embodiment.

FIG. 3 is front view of a trailer support, according to an example embodiment.

FIG. 4 is an exploded view of the lifting mechanism associated with a trailer support, according to an example embodiment.

FIG. 5 is a side view of a turning collar, according to an example embodiment.

FIG. 6 is a wheel driving apparatus, according to an example embodiment.

FIG. 7 is a schematic view of wiring for the jack apparatus, according to an example embodiment.

FIG. 8 is a schematic view of control device, according to an example embodiment.

FIG. 9 is a flow diagram of a method associated with the trailer support or jack, according to an example embodiment.

FIG. 10 is a schematic diagram of a computer system and media, according to an example embodiment.

FIG. 11 illustrates a computer readable medium having a set of instructions, according to an example embodiment.

The description set out herein illustrates the various embodiments of the invention, and such description is not intended to be construed as limiting in any manner.

### DETAILED DESCRIPTION

In the following detailed description of the preferred embodiments, reference is made to the accompanying drawings that form a part hereof, and in which are shown by way of illustration specific embodiments in which the invention can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of present inventions. The following detailed description, therefore, is not to be taken in a limiting sense, and the scope of various embodiments of the invention is defined only by the appended claims, along with the full range of equivalents to which such claims are entitled.

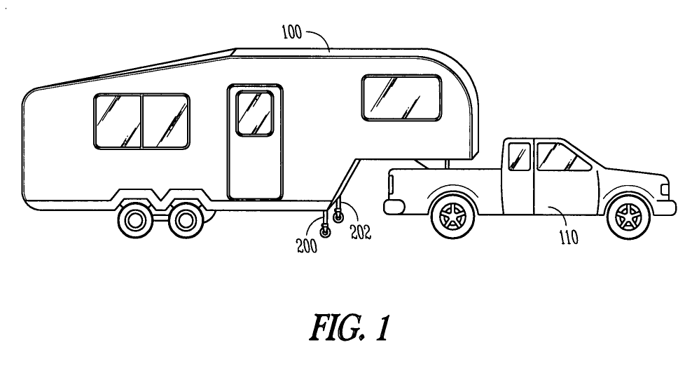

FIG. 1 is perspective view a trailer support or jack 200 positioned or attached to a trailer 100, according to an example embodiment. A third wheel type trailer 100 is shown in FIG. 1. The trailer includes a hitch that attaches to another portion (not shown) carried in the bed of a tow vehicle, such as a pickup truck 110. The trailer 100, therefore, has no wheels or other support located at or near the front of the trailer 100 other than the trailer supports 200 and 202. The trailer supports 200, 202, are located toward or near the front of the trailer 100. The trailer supports 200, 202 are used to detach the trailer from the towing vehicle 110 and to support the trailer and specifically the free end that attaches to the hitch on the tow vehicle 100. The trailer supports 200, 202 can be adjusted to level the trailer 100. The trailer supports 200, 202 are also powered to lift the trailer 100 and level the trailer 100. The trailer supports 200, 202 can also be pivotally attached so that they can be placed in a stowed position while the trailer 100 and the tow vehicle 110 are underway. The trailer support 200, 202 are also powered and can be driven so that the trailer supports 200, 202 can be used to move the trailer. In addition to driving the trailer supports 200, 202 to drive the trailer 100, the trailer supports can also be used to steer the trailer 100 while it is being driven. In this manner, the trailer supports 200, 202 can be used to reposition the trailer 100 such as when the towing vehicle is placed near the trailer 100. The trailer supports 200, 202 can be used to move the trailer 100 into a position to facilitate the hitching of the trailer 100 to the hitch. It should be noted that these trailer supports 200, 202 are not limited to fifth wheel type trailers 100 and can be used on other trailers, such as semi tractor trailers and the like. The trailer supports 200, 202 can also be used on smaller type trailers such as those associated with a speed boat or utility trailer. In some embodiments, one trailer support may be used. In other embodiments, more than two trailer supports may be employed.

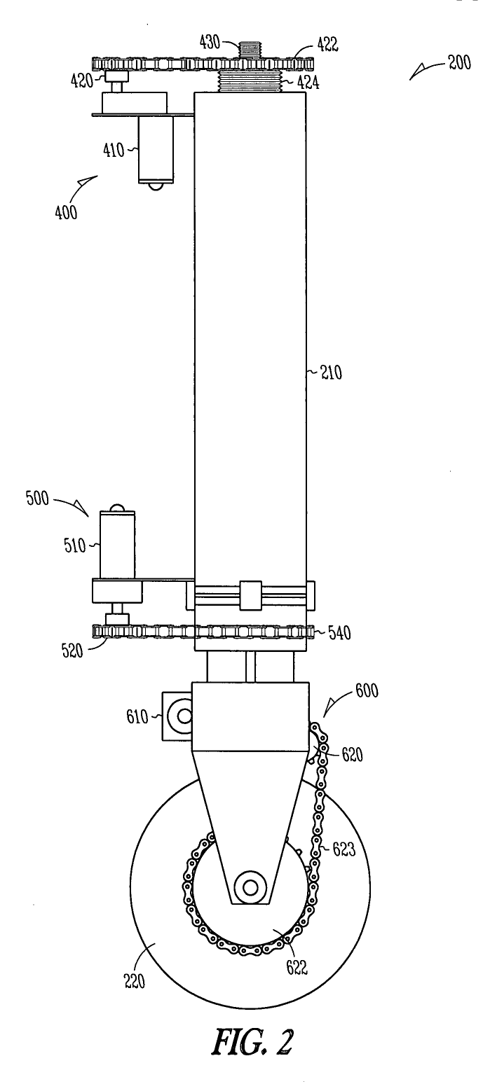

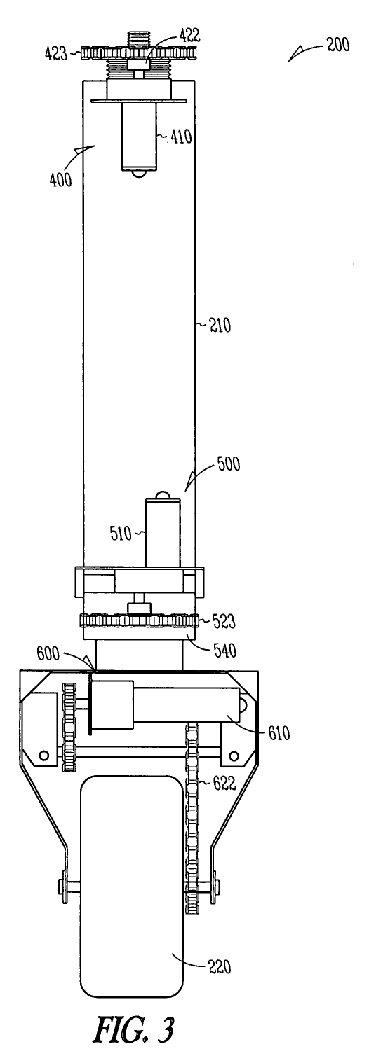

FIG. 2 is a side view of a trailer support or jack 200 according to an example embodiment. FIG. 3 is a front view of a trailer support 200 or jack according to an example embodiment. Now referring to both FIGS. 2 and 3, the trailer support 200 will be further detailed. The trailer support 200 includes a main body 210, a wheel 220, a lifting mechanism 400, a steering mechanism 500, and a drive mechanism 600. The drive mechanism 600 drives the wheel 220. The lift mechanism 400 includes a lift driver 410 which turns a first sprocket 420. The first sprocket 420 drives a second sprocket 422. The second sprocket 422 includes a threaded hub 424. Lift mechanism 400 also includes a threaded shaft 430. The threaded shaft 430 fits within the threads of the threaded hub 424. The drive mechanism also includes a driver 610 which drives a first sprocket 620 which in turn drives a second sprocket 622. The second sprocket 622 is attached to the wheel 220. By turning the sprocket 622 the wheel 220 is driven. A chain 623 attaches the first sprocket 620 to the second sprocket 622.

The steering mechanism 500 includes a steering driver 510. The steering driver includes a first sprocket 520, a chain 523, and a collar 530. The chain 523 attaches to the collar 540 or turning collar 540. The turning collar 540 is rotatably attached or rotatably mounted to the main housing 210 of the trailer support 200. Thus by turning the sprocket 520 the chain attached to the sprocket 520 turns the turning collar 540 thereby steering the wheel 220.

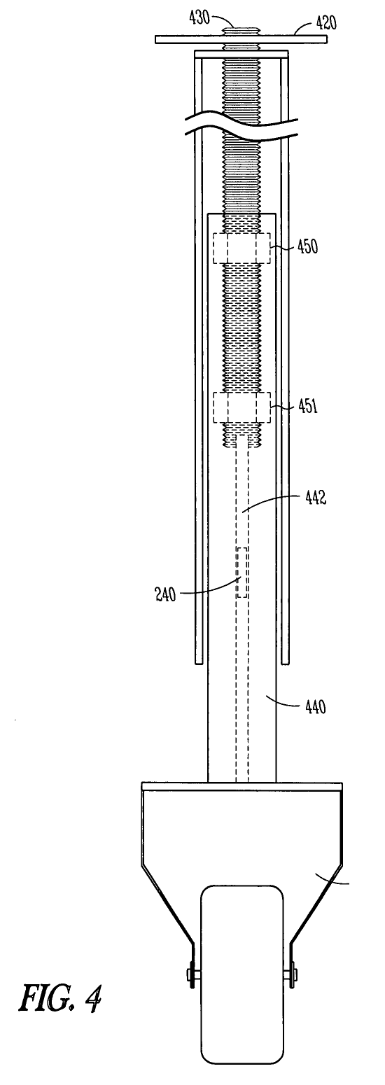

FIG. 4 is a side cutaway view of a lifting mechanism associated with the trailer support 200, according to an example embodiment. Portions of the trailer support 200 have been removed from the sake of clarity. The lifting mechanism 400 includes the sprocket 420 as well as the threaded shaft 430. The housing 210 is actually an external housing. A barrel 440 fits within the housing 210. One of either the barrel 440 or the housing 210 includes a key way 442. In actuality there are two key ways (one not shown) formed within the barrel 440. The key ways are along the outside surface of the barrel 440. The external housing or housing 210 also includes a corresponding number of keys, such as key number 240. The key 240 rides within the key way 440 as the housing 210 moves with respect to the barrel 440. Within the barrel is at least one internally threaded member 450. As shown in FIG. 4 there are actually two threaded members 450 and 451 located inside the barrel 440. In one embodiment the internal threaded members 450, 451 are internally threaded nuts. During fabrication the threaded members or nuts 450, 451 are attached to the internal portion of the barrel 440 through ⅞ inch holes located through the wall of the barrel 440. In other words, the nut or threaded member 451, 452 is welded to the internal surface of the barrel via a rosette weld.

Driving the sprocket 420 in turn drives the threaded member 430 to move the threaded member 430 with respect to the two internal threaded members 450, 451. The threaded member 430 carries the external housing so that as the internal member 430 is threaded into or out of the internally threaded members 450, 451 the housing 210 moves with respect to the barrel 440. The channel or key way 442 and the keys 240, 242 which ride within the key ways 442 control the motion of the barrel with respect to the outer housing 210. In other words, the key and key way arrangement prevents the outside housing 210 from rotating with respect to the barrel 440. A fork 222 is attached to the bottom or the free end of the barrel 440. The fork 222 captures both ends of an axle upon which the wheel 220 and the sprocket 622 attach to the wheel are able to rotate.

FIG. 5 is a side view of a turning collar 540 and a portion of the external housing 210. The turning collar includes a lug 541 and a lug 542. The lug 541 and the lug 542 are attachment points for the chain 523 (shown in FIG. 3). In other words, the lugs 541, 542 act as linkages to which the chain 523 can link. The turn collar 540 includes a key or set of keys (not shown) which fit within the ends of the key ways (such as key way 442) shown in FIG. 4. In other words, the turning collar 540 includes keys which fit into the key ways 442 of the barrel 440. The turning collar is attached to the bottom of the housing 210 using a set of channel portions such as 551 and 552. Therefore the turning collar 540, will move with the housing 210 which in turn will turn the barrel 440 to which the fork 222 is attached. Therefore, by turning the turning collar 540, the wheel 220 will turn. The chain 523 used to drive the turning collar 540 provides a reliable linkage. In some embodiments it may be a hard linkage such as a rod or other linkage may also be used. A chain is thought to have advantages in terms of wear and maintenance in some applications.

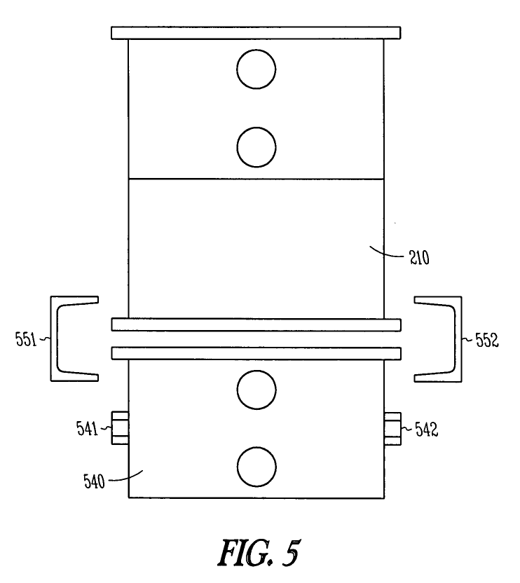

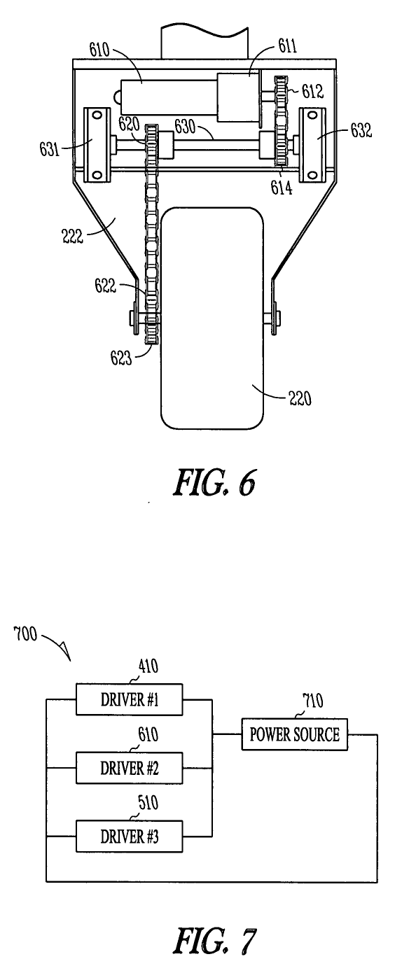

FIG. 6 is a wheel driving apparatus 600, according to an example embodiment. The wheel driving apparatus 600 fits within the fork 222. The wheel driving apparatus 600 include the motor 610 which drives a sprocket 612. The motor driving apparatus also includes a drive shaft 630. The drive shaft 630 is captured on at or near two ends of the drive shaft 630 by a first ball bearing and a second ball bearing having the reference numerals 631 and 632 respectively. A second sprocket 614 is attached to the drive shaft 630. A chain is attached between the first sprocket 612 and the second sprocket 614. Thus turning or rotating the driver 610 rotates the sprocket 612 and the drive shaft 630 by way of sprocket 614. The driver 610 is also attached to a gear box 611. The gear box 611 provides added torque for spinning or rotating the sprocket 612 as well as the sprocket 614 and the drive shaft 630. Sprocket 620 is also attached to the drive shaft 630 and is aligned with the sprocket 622 attached to the wheel 220. Therefore, by enabling the driver 610 through the gear box 611 the various sprockets 612 and 614, as well as the chain 615, turn or rotate the drive shaft 630. The sprocket 620, through chain 623 and sprocket 622, then turns the wheel 220. The driver 610 is capable of going in two directions therefore the sprockets can drive the wheel 220 in two directions. It should be noted that a wheel is not necessary in all applications. In some embodiments of the invention a track may be substituted or driven by the chain 623 and the sprocket 622. Such embodiments might be used in conditions that are muddy or produce difficulties with respect to traction. In other words, track may be used in a lower traction or lower friction environment.

FIG. 7 is a schematic view of a wiring for a trailer support 200 or 202, according to an example embodiment. The wiring diagram 700 includes a power source 710. The power source is wired in parallel to a first driver, a second driver, and a third driver. In one embodiment of the invention the first driver corresponds to an electric motor 410 associated with a lift mechanism. The second driver corresponds to an electric motor 610 associated with the locomotion or wheel drive mechanism, and the third driver corresponds to an electric motor 510 associated with the steering mechanism. The power source 710 can be any type of power source and located in any location. In one embodiment of the invention the power source 710 is associated with the trailer 100. The trailer 100 in some instances, will include a power source for powering a brake associated with a trailer. The braking system provides brakes for the trailer in the event that the trailer should become detached from the towing vehicle 110. In one of the embodiments the power source associated with the trailer 710 is used to power the various drivers 410, 510, 610 associated with the trailer support 200. In another embodiment more than one of these lift supports may be driven by the same power supply or power source 710.

FIG. 8 is a schematic view of a control device 800, according to an example embodiment. The control device includes a set of switches for enabling the first driver, the second driver, and the third driver. The control device 800 includes a housing 810. Within the housing are mounted a first switch 820 which is capable of driving the locomotion mechanism or the wheel. The switch 820 includes three positions. In the first position the motor 610 is driven in a first direction to produce forward motion. In the second position the motor 610 is driving in an opposite position to produce a backward direction. The resting or default position is to have the motor 610 be off or not enabled. The second switch 830 controls the steering. In the first position it steers to the left; in the second position the motor 510 goes into the opposite direction to steer to the right. This can be toggled to produce different amounts of steering and in the third position there is an off position or default position so that once the wheel is moved in a direction, it maintains that same angular displacement. The third switch enables the brake. In default position the brake is on. In a second position the brake is off. This of course is the brake that is associated with the trailer 100. A fourth switch controls the lift mechanism. In a first position the lift motor 410 is driven in a first direction to produce a downward movement of between the housing 210 and the barrel 440. In other words, the barrel and the housing are moving so that the barrel is inserted within the housing. In a second position the motor 410 is turned such that the barrel moves outside or telescopes out of the housing 210 which produces an upward motion of the jack or lengthening of the trailer support. The middle position is an off position so that once an appropriate height, or desired height, is achieved the switch will go to a default off position and maintain that height.

An apparatus includes a trailer support, and a lift mechanism attached to the trailer support. The apparatus also includes a first drive unit attached to the trailer support, and a second drive unit attached to the trailer support. The first drive unit steers the trailer support. The second drive unit moves the jack. In some embodiments, the second drive unit drives a wheel for locomotion of the jack. In other embodiments, the second drive unit drives a track for locomotion of the jack. The trailer support further includes a portion for connecting to a trailer; and an electrical connection portion in electrical communication with the first drive unit and the second drive unit. The trailer includes a power source. In one embodiment, the electrical connection portion of the apparatus is in electrical communication with the power source associated with the trailer. The apparatus, in some embodiments, also includes a remote controller for controlling the first drive unit and the second drive unit. In one embodiment, the remote controller is wireless. In another embodiment, the trailer support unit includes a wheel, and the second drive unit drives the wheel. In still another embodiment, the trailer support unit includes a track, and the second drive unit drives the track. In yet another embodiment, the apparatus also includes a third drive unit attached to the trailer support. The third drive unit drives the lift mechanism. In another embodiment, the remote controller controls the first drive unit, the second drive unit, and the third drive unit. The trailer can include a power source, and a braking system enabled by the power source. The remote controller, in some embodiments, controls the braking system.

A system includes a trailer, a trailer support, a lift mechanism attached to the trailer support, a first drive unit attached to the trailer support, and a second drive unit attached to the trailer support. The first drive unit steers the trailer support. The second drive unit moves the trailer. In some embodiments, the trailer includes a power source for enabling a brake. The system also includes an electrical connection to the power source of the trailer. The power source of the trailer powers the first drive unit and the second drive unit. The remote then may be configured to control the first drive unit, the second drive unit and the brake. In other embodiments, the remote also controls the lift mechanism. The second drive unit drives a wheel for locomotion of the trailer or drives a track for locomotion of the trailer.

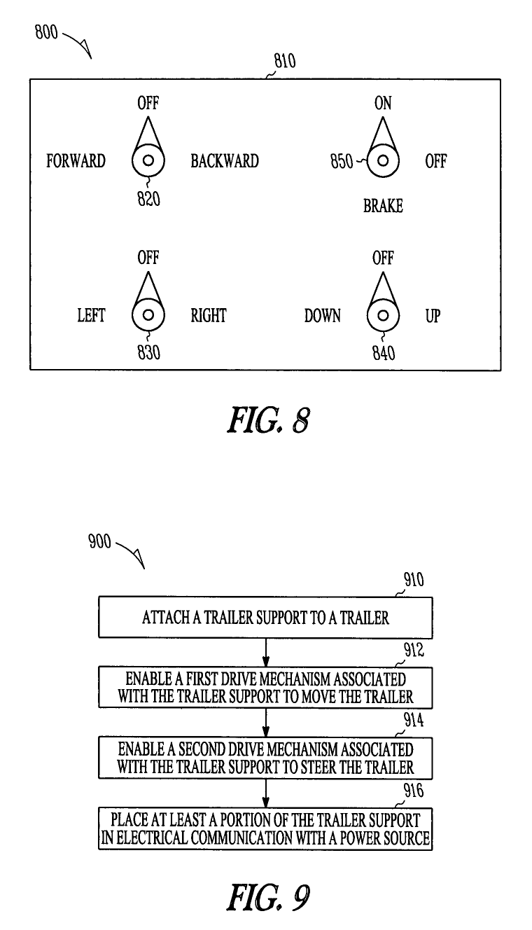

FIG. 9 is a flow diagram of a method 900 associated with the trailer support or jack, according to an example embodiment. The method 900 includes attaching a trailer support to a trailer 910, enabling a first drive mechanism associated with the trailer support to move the trailer 912, and enabling a second drive mechanism associated with the trailer support to steer the trailer 914. The method also includes placing at least a portion of the trailer support in electrical communication with a power source 916. The power source powers the first drive mechanism and the second drive mechanism. The method 900, in some embodiments, also may include controlling the first drive mechanism and the second drive mechanism remotely.

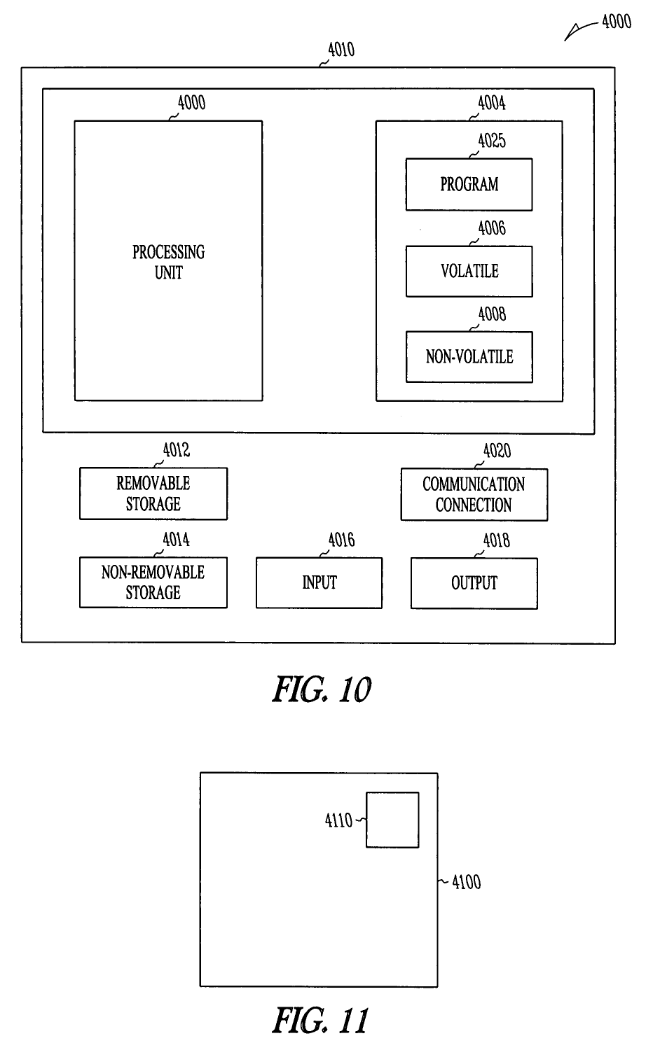

FIG. 10 is a block diagram of a computer system 4000, according to an example embodiment. The computer system 4000 executes programming for performing the above-described methods. A general computing device in the form of a computer 4010, may include a processing unit 4002, memory 4004, removable storage 4012, and non-removable storage 4014. Memory 4004 may include volatile memory 4006 and non-volatile memory 4008. Computer 4010 may include, or have access to a computing environment that includes, a variety of computer-readable media, such as volatile memory 4006 and non-volatile memory 4008, removable storage 4012 and non-removable storage 4014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 4010 may include or have access to a computing environment that includes input 4016, output 4018, and a communication connection 4020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

FIG. 11 illustrates a computer readable medium 4100 having a set of instructions 4110, according to an example embodiment. Computer-readable instructions 4110 stored on a computer-readable medium 4100 are executable by the processing unit 4002 of the computer 4010. A hard drive, CD-ROM, and RAM are some examples of articles including a computer-readable medium. For example, a computer program 4025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 4000 to provide generic access controls in a COM based computer network system having multiple users and servers.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. An apparatus comprising:
a trailer support;
a lift mechanism attached to the trailer support;
a first drive unit attached to the trailer support, the first drive unit for steering the trailer support; and
a second drive unit attached to the trailer support, the second drive unit for moving the jack.

2. The apparatus of claim 1 wherein the second drive unit drives a wheel for locomotion of the jack.

3. The apparatus of claim 1 wherein the second drive unit drives a track for locomotion of the jack.

4. The apparatus of claim 1 wherein the trailer support further comprises
a portion for connecting to a trailer; and
an electrical connection portion in electrical communication with the first drive unit and the second drive unit.

5. The apparatus of claim 4 wherein the trailer includes a power source, the electrical connection portion placing the first drive unit and the second drive unit in electrical communication with the power source associated with the trailer.

6. The apparatus of claim 1 further comprising a remote controller for controlling the first drive unit and the second drive unit.

7. The apparatus of claim 6 wherein the remote controller is wireless.

8. The apparatus of claim 1 wherein the trailer support unit includes a wheel, the second drive unit driving the wheel.

9. The apparatus of claim 1 wherein the trailer support unit includes a track, the second drive unit driving the track.

10. The apparatus of claim 1 further comprising a third drive unit attached to the trailer support, the third for driving the lift mechanism.

11. The apparatus of claim 10 further comprising a remote controller for controlling the first drive unit, the second drive unit, and the third drive unit.

12. The apparatus of claim 11 wherein the trailer further comprises:
a power source: and
a braking system enabled by the power source.

13. The apparatus of claim 12 wherein the remote controller controls the braking system.

14. A system comprising:
a trailer;
a trailer support;
a lift mechanism attached to the trailer support;
a first drive unit attached to the trailer support, the first drive unit for steering the trailer support; and
a second drive unit attached to the trailer support, the second drive unit for moving the trailer.

15. The system of claim 14 wherein the trailer further comprises a power source for enabling a brake, the system further comprising an electrical connection to the power source to power the first drive unit and the second drive unit.

16. The system of claim 15 further comprising a remote for controlling the first drive unit, the second drive unit and the brake.

17. The system of claim 16 where the remote also controls the lift mechanism.

18. The system of claim 14 wherein the second drive unit drives a wheel for locomotion of the trailer.

19. The system of claim 14 wherein the second drive unit drives a track for locomotion of the trailer.

20. A method comprising:
attaching a trailer support to a trailer;
enabling a first drive mechanism associated with the trailer support to move the trailer; and
enabling a second drive mechanism associated with the trailer support to steer the trailer.

21. The method of claim 20 further comprising placing at least a portion of the trailer support in electrical communication with a power source, the power source powering the first drive mechanism and the second drive mechanism.

22. The method of claim 20 further comprising controlling the first drive mechanism and the second drive mechanism remotely.
